(19) United States
(12) Patent Application Publication
(10) Pub. No.: US 2006/0207114 A1
(43) Pub. Date: Sep. 21, 2006

(54) Drafting compass

(76) Inventor: Arthur G. Stoner, Glen Allen, VA (US)

Correspondence Address: JOHN H. THOMAS, P.C., 536 GRANITE AVENUE, RICHMOND, VA, 23226, US

(21) Appl. No.: 11/373,944

(22) Filed: Mar. 13, 2006

Related U.S. Application Data
(60) Provisional application No. 60/662,261, filed on Mar. 16, 2005.

(51) Int. Cl. B43L 9/04

(52) U.S. Cl. 33/27.03

(57) ABSTRACT

The invention relates to drafting equipment and, more particularly, pertains to a new and improved drafting compass for use with brittle or delicate surfaces. The drafting compass includes an arm rotatable about a bearing axis or axis of rotation. An instrument block is selectively securable along the length of the arm, and the block includes means to selectively secure writing instruments of various sizes.

This application hereby claims the priority benefits of U.S. Provisional Application Ser. No. 60/662,261, which was filed on Mar. 16, 2005.

### FIELD OF THE INVENTION

The present invention relates to drafting equipment and, more particularly, pertains to a new and improved drafting compass for use with brittle or delicate surfaces.

### BACKGROUND

Drafting equipment, in general, is a well developed art area that has seen incremental improvements over the years. Each improvement tends to solve specific deficiencies or the specified needs of an industry. For example, drafting equipment improvements have been specifically directed to architects, map makers, teachers, and the like. Improvements have also been made to lessen the cost and complexity of existing drafting tools.

Many schools, teaching facilities, and researchers make presentations on chalkboards or whiteboards for use in classrooms or labs. When teaching a class, such as a math class, it is common to teach and demonstrate the use of a compass to form various geometric shapes. Compasses historically include a sharp point for a center anchor or bearing point, which would inevitably damage or ruin a chalkboard, whiteboard or the like. Whiteboards can be comprised of many materials but are typically used with dry erase markers or other writing utensils.

It is also desirable to make a presentation using multiple colors to represent distinct geometric shapes. Multiple colors help illustrate the presenter's topic and can speed the understanding of the subject that is being conveyed, particularly for a younger audience. Typical drafting compasses do not provide the ability to readily change the writing instrument. A compass may include replaceable writing instruments, but the replacement does not occur quickly enough to satisfy a presenter. Known compasses are also thought to be deficient at accommodating different types and sizes of writing instruments. For instance, it may be necessary to move from a whiteboard to a chalkboard, but a single compass may not be suitable for use with both a whiteboard marker and a piece of chalk. The main problem being that erasable markers used for whiteboards have a relatively large diameter in comparison to most writing instruments. Known drafting compasses cannot accommodate these large size markers and/or cannot accommodate multiple instruments with different dimensions.

Known compasses also tend to favor a user that is right handed. A compass for a delicate surface is not known to exist that can be easily adapted to a user that is dominant in either their left or right hand.

Therefore, there exists a need and a challenge to create a drafting compass that is able to be used on a brittle or delicate surface without damaging the board. Ideally, the compass would allow for interchangeable writing instruments, would accommodate writing instruments of various sizes, and would be selectively adjustable to create arcs or circles of different radii. The compass would also be quickly adaptable to user who is left or right handed. The compass would also be inexpensive, easy to operate, and would present a new compass construction assembly. The compass of the present invention solves one or more of these or other needs.

### SUMMARY OF THE INVENTION

In accordance with the present invention, a drafting compass is provided that allows for accurate drafting on a brittle or delicate surface material without marking or damaging the surface. The drafting compass of the present invention also includes a means to readily exchange the writing instrument, and the compass accommodates both relatively large and small writing instruments.

The drafting compass of the present invention, in the broadest terms, includes a soft tipped bearing axis to be placed against a brittle or delicate surface. An arm extends perpendicularly from the bearing axis. An instrument block selectively slides along the arm and retains a writing instrument. The writing instrument is parallel to the axis of rotation/bearing axis and is in contact with the surface to be marked upon. Therefore, rotating the arm around the bearing axis draws an arc or circle with a constant radius.

In greater detail, the drafting compass of the present invention includes a threaded fastener or shaft, such as a bolt. A soft tip is securely placed over one end of the shaft. An optional washer is placed on the shaft between the soft tip and a rotatable barrel located around the shaft. The arm, which is an elongated member with an axis perpendicular to the axis of the shaft, extends from the barrel. The arm terminates at a first end distal from the barrel. The second end of the arm forms or joins to the barrel. The barrel is dimensioned to accept the shaft, which extends through both ends of the barrel. A knurled nut is placed on the shaft following the barrel. Finally, a knob is threaded onto the shaft until it engages the knurled nut. Each component forming the shaft assembly is in physical contact with the adjacent component(s). The shaft assembly forms the center point or bearing axis that is pressed against a brittle or delicate surface.

An instrument block is also provided on the arm in a slidable relationship. The block is a machined or molded member with a transverse aperture through the width of the block. The block aperture is dimensioned to slidably fit onto the radius arm via the first end of the radius arm. A marking receptacle in the block is sized to accept markers of various sizes through the height of the block. Markers are, therefore, held in a parallel alignment with the shaft. Fasteners, such as thumb screws, allow the user to selectively secure or release the instrument block relative to both the arm and the writing instrument. The block can be mounted on the arm in a number of positions in order to adapt to a user's preference or to facilitate use for a right or left handed individual.

A drafting compass in accordance with the present invention efficiently address at least one of the shortcomings associated with prior art drafting compasses. The foregoing and additional features and advantages of the present invention will become apparent to those of skill in the art from the following detailed description of a preferred embodiment taken in conjunction with the accompanying drawings.

### BRIEF DESCRIPTION OF THE DRAWINGS

FIG. 1 is a perspective view of a drafting compass in accordance with one embodiment of the present invention;

FIG. 2 is a front view thereof;

FIG. 3 is a back view thereof;

FIG. 4 is a top view thereof;

FIG. 5 is a bottom view thereof; and

FIG. 6 is a perspective view of the drafting compass of the present invention wherein the various parts are illustrated in a spaced relationship, the drafting compass being in accordance with one preferred embodiment of the present invention.

### DETAILED DESCRIPTION

A drafting compass in accordance with the present invention provides an inexpensive, easy to operate, durable, and selectively adjustable instrument. The drafting compass provides accurate geometric shapes, is useable with delicate or brittle writing surfaces, and accommodates writing utensils of various sizes. The compass is adaptable to a left or right handed user.

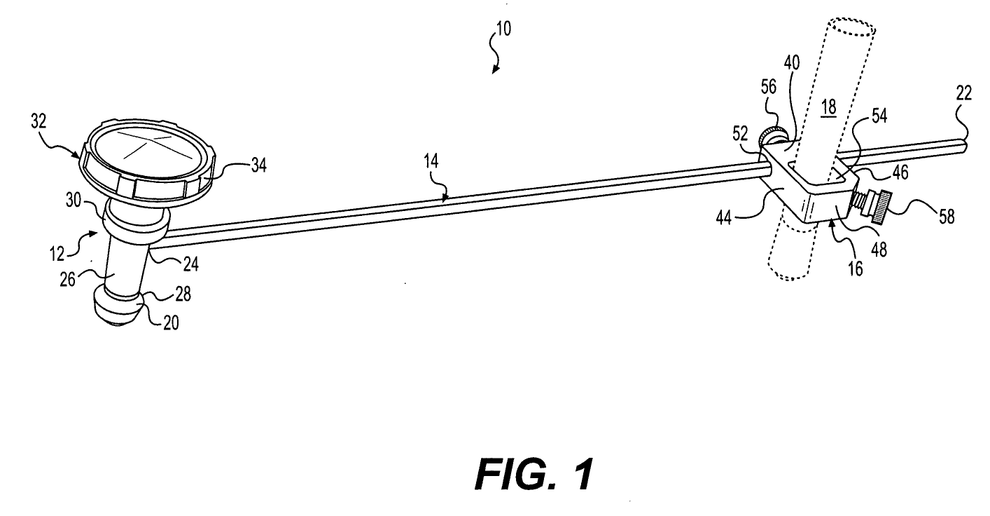

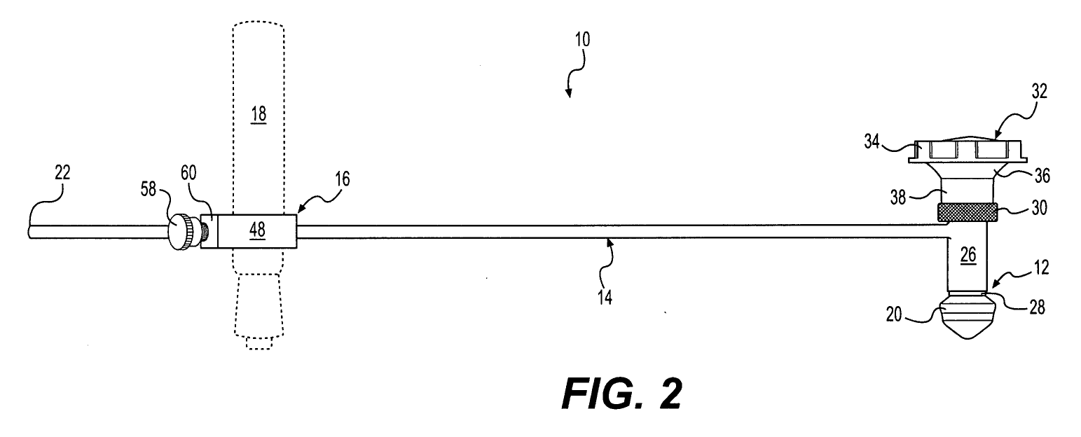

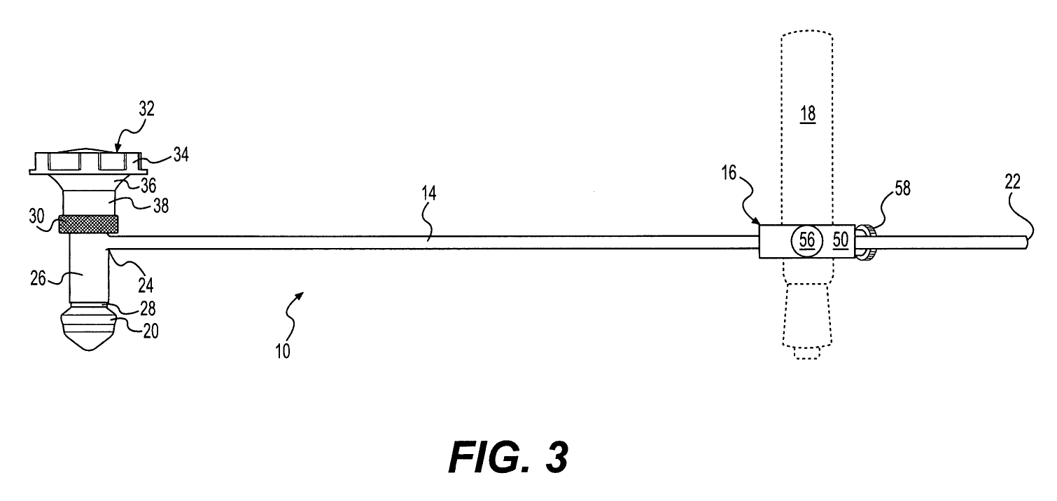

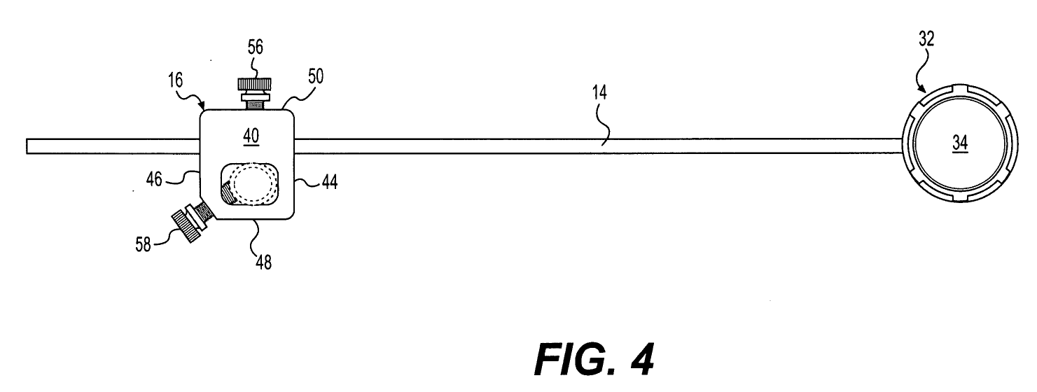

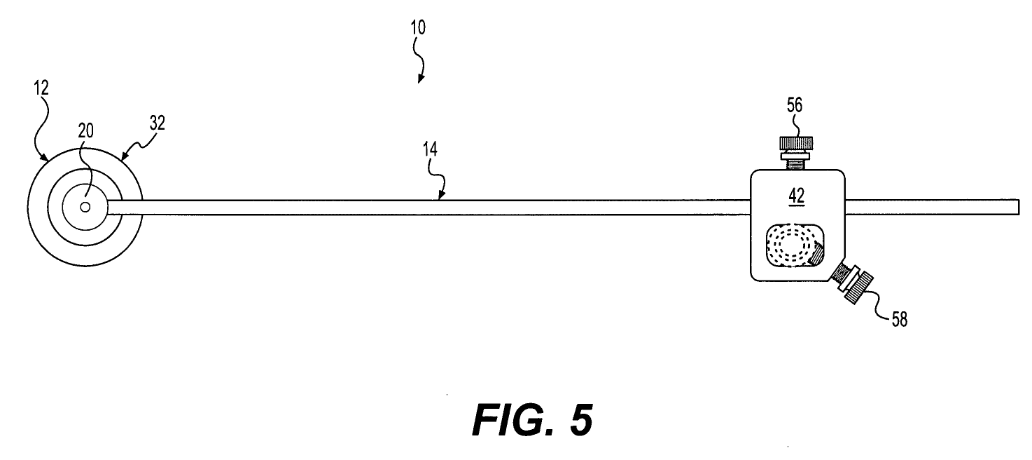

Turning to FIGS. 1-5, there is illustrated a drafting compass 10 from multiple angles that is in accordance with at least embodiment of the present invention. The compass's axis of rotation or bearing axis is defined by shaft assembly 12, which has a first end and a second end. An arm 14 extends from the shaft assembly perpendicular to the axis of the shaft assembly. Arm 14 rotates about the bearing axis. An instrument block 16 is slidable along the length of the arm. Block 16 holds a writing instrument 18. The instrument, as illustrated, represents a whiteboard marker, but, as will be discussed further below, instruments of various sizes and materials can be easily incorporated. The compass is operable to form geometric shapes with a constant radius.

In greater detail, the first end of shaft assembly 12 is a soft tip 20. The tip is a molded polymer, such as rubber, neoprene, or the like, although various materials and construction techniques would be suitable to form the tip. ‘Soft’, for the purposes of this invention, implies that tip 20 acts as a cushion between shaft assembly 12 and a surface to be drawn upon with compass 10. Therefore, drafting compass 10 is thought to be suitable for use with delicate or brittle surfaces such as chalkboards, whiteboards and the like. Tip 20 is fixed to the assembly in that it does not rotate individually from the other components of the assembly.

Radius arm 14 is an elongated member extending perpendicularly from shaft assembly 12. In one preferred embodiment, arm 14 is a metal rod with a square cross section (approximately 3/16× 3/16×14.5 inches). Arm 14 terminates at a first end 22 distal to assembly 12. A second end 24 is secured to a barrel 26 that is a part of the assembly. The arm is joined to the barrel by known method such as welding, adhesive, or the like. It is also envisioned that arm 14 may be comprised of other materials, such as a machined or molded plastic. The dimensions of the arm can vary based upon consumers desires and the particular application for which the compass will be used. It is also envisioned that the arms of different dimensions might be exchanged onto a single compass.

In one preferred embodiment, arm 14 and barrel 26 are integral and therefore, consist of a single piece of metal, plastic, or other suitable material. As either a single piece or a plurality of pieces, barrel 26 and arm 14 are independently rotatable about the axis defined by the shaft assembly 12. A washer 28 is optionally located between barrel 26 and tip 20. Washer is operable to reduce friction between the tip and the barrel.

Shaft assembly 12 further comprises a nut 30 adjacent to barrel 26 opposite tip 20. A knob 32 defines the second end of the assembly. Nut 30, which is a knurled nut in one preferred embodiment, is positioned between barrel 26 and knob 32.

Knob 32 is commonly a molded plastic piece with an upper portion (i.e., the portion furthest from tip 20) forming a gripable handle 34 to be engaged by a user. Handle 34 can comprise a smooth or textured shape. Knob 32 further includes a neck portion 36 that tapers the diameter of knob 32 inwards from handle 34 to a vertical column 38 having a reduced diameter. Column 38 is in contact with nut 30, and typically handle 34 will have a larger diameter than the diameter or width of assembly 12, in general, and/or nut 30. The user places a rotating force on knob 32 via handle 34. Column 38 engages and rotates the nut, which in turn engages and rotates the barrel 26. The relatively large diameter for handle 34 provides a user with better leverage on compass 10.

Block 16 on arm 14 includes an upper surface 40, a lower surface 42, left and right sidewalls 44, 46, and front and back ends 48, 50. Although described and illustrated as a rectilinear shape, block 16 can be formed to any number of suitable shapes. A variety of materials, such as plastics/polymers, metals, and the like are suitable. Arm 14 is slidably mounted onto the arm and can be selectively positioned from immediately proximate assembly 12 to any other point along arm 14.

In one preferred embodiment, block 16 is placed on arm 14 via a first aperture 52 that passes through block 16 along an axis perpendicular to the axis of shaft assembly 12. As illustrated, aperture 52 passes through block 16 from left sidewall 44 to right sidewall 46. Arm 14 is inserted into aperture 52. Aperture 52 will generally mimic the cross sectional shape of arm 14, but will exhibit slightly larger dimensions so that block 16 can be readily positioned along the length of the arm.

A second aperture 54 in block 16 pass through block 16 along an axis parallel to the axis of shaft assembly 12. As illustrated, aperture 54 passes through block 16 from upper surface 40 to lower surface 42. Second aperture 54 is sized and dimensioned to accept writing instruments of various sizes. The channels defined by the first and second apertures do not intersect.

To facilitate the positioning of block 16 relative to arm 14 and the ready exchange or replacement of writing instrument 18, threaded fasteners are utilized to selectively and individually intersect the axis of the first and second apertures. Specifically, a first fastener 56 passes through block 16 along a path intended to intersect the axis of first aperture 52. Therefore, fastener 56 engages the arm when the arm has been inserted through the aperture. Fastener 56 acts to secure the block to the arm. The fastener generally has a blunt shank to prevent damage to arm 14. In one preferred embodiment, fastener 56 is a thumb screw with a blunt shank.

Likewise, a second threaded fastener 58 facilitates the easy, selective securement and exchange of writing instruments passing through aperture 54. Second fastener 58 passes through block 16 along a path intended to intersect the axis of second aperture 54. Where an instrument has been inserted into aperture 54, fastener 58 physically engages the instrument and holds the instrument between the fastener and the interior of the aperture. Therefore, a user continues to thread the fastener into block 16 until the instrument is frictionally and compressively held between fastener 58 and the interior walls of aperture 54. Fastener 58 can take many forms but is preferably a thumb screw with a blunt shank.

The location of both the apertures through the block and the path of the fasteners to intersect the apertures can vary, as would be obvious to one of skill in the art. As illustrated, one preferred embodiment is to mold or machine block 16 to include first aperture 52 proximate to back end 50. Fastener 56 enters back end 50 perpendicular to the surface of back end 50. This alignment places the shank of fastener 56 perpendicular to the axis of aperture 52. The fasteners preferably pass through pre-formed channels that are molded, machined, or otherwise built into the block.

Second aperture 54 is proximate front end 48. Fastener 58 can be placed at any angle that would intersect the axis of aperture 54 so long as the path of the fastener does not intersect with aperture 52 or the path of fastener 56.

Aperture 54 is illustrated with a square profile to accept writing instruments of various sizes and shapes. In a preferred embodiment, the exterior shape of block 16 includes a mitered corner 60 at the intersection of front end 48 and either sidewall. In this embodiment, fastener 58 enters the front corner of block 16 so that the fastener intersects the axis of aperture 54 along a path aligned from one interior corner of aperture 54 towards an opposing corner. The advantage being that circular instruments 18 are compressed against two of the walls defined by the square-shaped aperture 54. The angle of the fastener through the aperture facilitates the securement of round instruments 18.

Block 16 is easily oriented to a number of positions. For instance, block 16, once removed from arm 14, might be rotated about an axis extending from the front end 48 to the back end 50. The result is that fastener or thumb screw 56 remains on the same side of arm 14, but sides 44 and 46 are flipped so that fastener or thumb screw 58 extends in a new direction.

Another optional configuration would be to remove block 16 from arm 14 and rotate the block about an axis extending from side 44 to side 46. Once returned to the arm, fastener 56 would be on the opposite side of the block. The block could be rotated about two axes. Using this ability, block 16 can easily be reoriented to a position to suit a user's preferences. For instance, a left handed user would orient the block so that while holding shaft assembly 12 with their right hand, they could easily operate the fasteners 56, 58 on the block with their left hand.

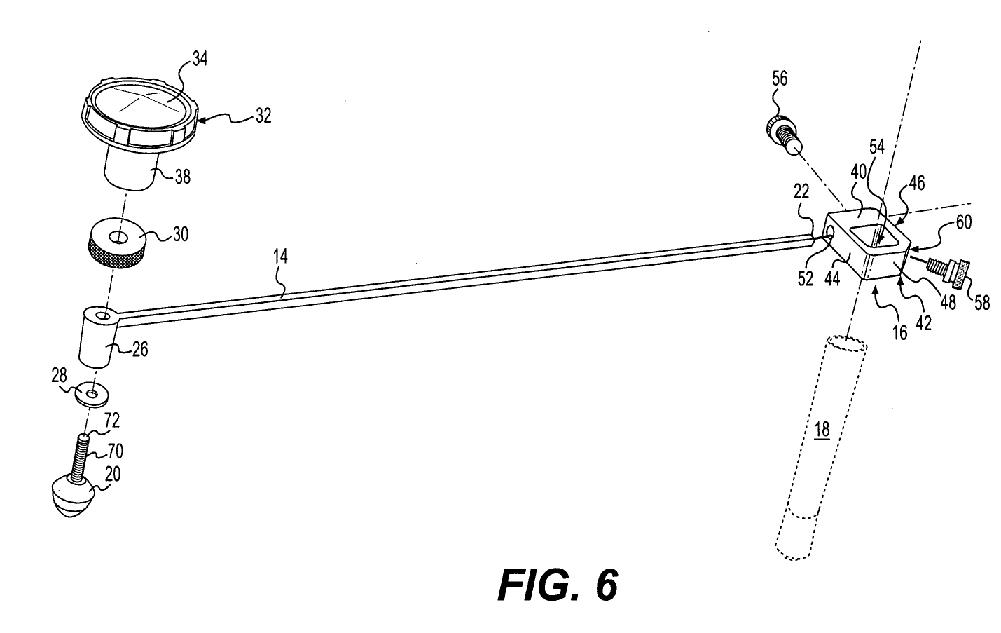

Turning to FIG. 6, there is illustrated one preferred embodiment of drafting compass 10 with the various components displayed in a spaced relationship. A threaded shaft 70 with a first end and a second end 72 forms the core of the shaft assembly. Soft tip 20 covers the first end of the shaft. Shaft 70 can be any fastener, such as a bolt, in which case tip 20 is fixed around the head of the fastener. Washer 20 is placed on shaft 70 next to the tip. The washer is followed by barrel 26, which does not engage the threads on the shaft. Nut 30 is placed on shaft 70 following the barrel. Finally, column 38 of knob 32 includes an interior, threaded diameter that threads onto shaft 70.

In use, the user places the shaft assembly against a surface to be drawn upon at a point about which an arc or circle will be illustrated. The shaft assembly is operable as a bearing axis for the illustrated geometric shape. The user grips and rotates knob 32. Knob 32 transmits the rotational force through nut 30 to barrel 26. As a result, barrel 26 and arm 14 rotate about shaft 70.

The radius or diameter of the resulting arc or circle may be varied by moving the block along the length of the arm. In use, the user rotates thumb screw 56 out of block 16 until fastener 56 no longer engages arm 14. The arm then slides towards and away from barrel 26 along the length of the arm. Graduation marks or indicators could be used to indicate to the user the size of the resulting arc or circle based on the location of the block on the arm. The user simply threads the fastener into the block when the block as been placed at the desired position on arm 14.

Similarly, the user can replace an instrument or exchange one instrument for another type of instrument by simply unscrewing fastener 58 far enough to allow the ingress and egress of the selected instruments with respect to aperture 56. With the instrument in place, fastener 58 is threaded into the block to secure the instrument.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A drafting compass for drawing a geometric shape upon a surface, the compass including a shaft assembly with a first end and a second end, the first end of the assembly being in contact with the surface, the shaft assembly operable as a bearing axis, the compass comprising:
a soft tip forming the first end of the shaft assembly;
a rotatable knob forming the second end of the shaft assembly;
a rotatable barrel between the soft tip and the knob;
an arm extending from the barrel perpendicular to the bearing axis defined by the shaft assembly;
an instrument block slidably mounted on the arm, the block selectively secured along the length of the arm; and
wherein the instrument block is adaptable to secure one of a variety of distinctly sized writing instruments in contact with the surface to be drawn upon.

2. The drafting compass of claim 1, further comprising a threaded shaft having a first end and a second end forming a core of the shaft assembly, the soft tip fixed upon the first end of the shaft, the knob threaded onto the second end of the shaft; and wherein the shaft extends through an interior diameter provided by the barrel, the barrel being freely rotatable about the shaft.

3. The drafting compass of claim 2, where in the threaded shaft is a bolt with a bolt head and the soft tip covers the bolt head.

4. The drafting compass of claim 2, further comprising a knurled nut on the shaft, the nut located between the knob and the barrel.

5. The drafting compass of claim 4, further comprising a washer on the shaft, the washer located between the soft tip and the barrel.

6. The drafting compass of claim 1, wherein the barrel includes an outer diameter and an inner diameter and the knob provides a handle with a diameter; wherein
the diameter of the handle is larger than the outer diameter of the barrel.

7. The drafting compass of claim 1 wherein the arm is joined to the barrel.

8. The drafting compass of claim 7 wherein the arm is integral to the barrel.

9. The drafting compass of claim 1, the block further comprising a first aperture passing through the block along an axis perpendicular to the bearing axis, the first aperture sized and dimensions to slide upon the arm; and
a second aperture passing through the block along an axis parallel to the bearing axis, the second aperture sized and dimensions to accept writing instruments wherein the first aperture and the second aperture do not intersect.

10. The drafting compass of claim 9, further comprising a first and second fastener associated with each of the first and second apertures in the block for selectively securing the block to the arm and selectively securing the writing instrument in the block, respectively.

11. The drafting compass of claim 10, wherein the first and second fasteners are thumb screws.

12. The drafting compass of claim 11, wherein the block is adaptable to slidably mount on the arm in a plurality of orientations, the block operable to secure the writing instruments in contact with the surface to be drawn upon in any orientation.

13. The drafting compass of claim 1, wherein the block is adaptable to slidably mount on the arm in a plurality of orientations, the block operable to secure the writing instruments in contact with the surface to be drawn upon in any orientation.

14. A drafting compass for drawing a geometric shape upon a surface, the compass including an axis of rotation, an arm extending perpendicularly from the axis of rotation, and a writing instrument supported on said arm, the compass comprising:
a threaded shaft defining the axis of rotation, the shaft having a first end and second end;
a soft tip fixed to the first end of the shaft, the first end of the shaft in contact with the surface to be drawn upon, the tip operable as a cushion between the threaded shaft and the surface;
a rotatable barrel positioned on the shaft proximate to the tip, the arm extending from the rotatable barrel;
a knob securely threaded onto the second end of the shaft;
a nut located between the knob and the barrel; and
wherein the manual rotation of the knob is transmitted via the nut to the barrel to cause the rotation of the barrel about the threaded shaft.

15. The compass of claim 14, wherein the threaded shaft is a bolt and the soft tip covers the head of the bolt.

16. The compass of claim 14, wherein a washer is positioned on the shaft between the soft tip and the barrel, the washer acting to reduce friction between the rotatable barrel and washer.

17. The compass of claim 14 further comprising an instrument block slidably mounted on the arm, the block selectively secured along the length of the arm, and the instrument block being adaptable to secure one of a variety of distinctly sized writing instruments in contact with the surface.

18. The drafting compass of claim 17, the block further comprising a first aperture passing through the block along an axis perpendicular to the axis of rotation, the first aperture sized and dimensions to slide upon the arm; and
a second aperture passing through the block along an axis parallel to the axis of rotation, the second aperture sized and dimensions to accept writing instruments wherein the first aperture and the second aperture do not intersect.

19. The drafting compass of claim 18, further comprising a first and second fastener associated with each of the first and second apertures in the block for selectively securing the block to the arm and selectively securing the writing instrument in the block, respectively.

20. The drafting compass of claim 19, wherein the first and second fasteners are thumb screws.

21. The drafting compass of claim 14, wherein the block is adaptable to slidably mount on the arm in a plurality of orientations, the block operable to secure the writing instrument in contact with the surface to be drawn upon in any orientation.
